(19) United States
(12) Patent Application Publication
(10) Pub. No.: US 2011/0237990 A1
(43) Pub. Date: Sep. 29, 2011

(54) Massage Apparatus with Spherical Elements

(76) Inventor: Lenaye Marsten, North Berwick, ME (US)

(21) Appl. No.: 13/124,431

(22) PCT Filed: Oct. 31, 2008
(86) PCT No.: PCT/US08/82003

§ 371 Date: Apr. 15, 2011

(51) Int. Cl. A61H 15/00

(52) U.S. Cl. 601/119

(57) ABSTRACT

An exercise device for promoting the natural movement and agility of facet joints in the spinal column is described The device is a facet joint exerciser having a pair of spheres rotatably mounted on a shaft that is assembled in a frame. The frame has a mounting yoke that attaches to a track. The track is mountable on a wall or other vertical surface. The frame is adjustable in height on the track. The spheres are dimensioned and spaced apart such that they can be pressed up against the spinal area of a person, so that the balls are close to either side of the spine and press into the support tissue on either side of the spine.

### BACKGROUND INFORMATION

1. Field of the Invention

The present invention relates to the field of exercise or massage equipment. More particularly, the invention relates to an exercise surface for relieving tense back tissue.

2. Description of the Prior Art

The human spine is usually constructed of 24 vertebrae that are stacked to a spinal column. Each vertebra has bone protrusions, called “transverse processes,” that extend laterally to each side of the spinal foramen on the posterior spinal column and that connect or interlock with corresponding transverse processes of adjacent vertebrae. These processes protect and provide stability to the spine. There are usually five spinous processes per vertebra, the fifth one being a singular posterior one. “Facet joints” are cartilaginous joints that provide a flexible cushion between transverse processes of adjacent vertebrae and allow the bony process of one vertebra to move relative to the process of the adjacent vertebra when the spinal columns flexes, bends, or twists. Looking at a posterior view of the spinal column, the facet joints of the vertebrae form a continuous, flexibly interlocked ridge along each side of the column, with a bilateral spinal groove formed between the transverse processes and the spinous processes that extend posteriorally along the center of the spinal column.

Supple unrestricted facet joints, muscles and ligaments enable the spine to painlessly flex, bend, and twist. Muscles and/or ligaments that support the facet joints can become restricted (unable to move fully in a natural fashion) or knotted (stiffened tissue). The facet joints themselves can become fixed in subluxation (out of joint or out of position). Restriction and/or stiffness of the back muscles and ligaments or subluxation of the facet joints results in stiffness and/or pain in the back and elsewhere, as well as limited movement. When this happens, common treatments include a back massage or chiropractic adjustment, with the goal of releasing the tension and correcting the restriction or subluxation.

Many devices to massage and relieve tension in the back exist. They almost all have a great disadvantage with regard to relieving stiffness or subluxation of the facet joints in that they are not constructed in a manner that adjusts the facet joints directly or massages the supportive tissue around the joints. The massage components are often too large or spaced too far apart to be effective. In the end, most such exercise devices apply some type of pressure to back muscles in general, without applying pressure directly to the facet joints. This type of exercise is ineffective in releasing tension, subluxation, and stiffness in the facet joints.

A further disadvantage of many back exercisers is that they are designed to be placed on the floor, forcing the user to get down onto the floor in order to use them. The act of getting into a supine position on a device that is close to floor level can cause discomfort to one already suffering from back pain and make it very difficult for the person to get up again after exercising.

What is needed, therefore, is an exercise device that will gently yet effectively relax knotted or tense muscles and ligamentous tissue that support the facet joints. What is further needed is such a device that will correct subluxation and adjust the facet joints. What is yet further needed is such a device that is simple and comfortable to use. Finally, what is needed is such a device that is lightweight and cost efficient to manufacture.

### BRIEF SUMMARY OF THE INVENTION

The invention is a facet-joint exerciser that gently releases and corrects subluxation in the facet joints along the spinal column and softens away knots and tension in the tissue supporting these joints. Much back pain and tension is caused by spinal subluxation, most of which, including rotation, is caused by fixation or stiffness in the muscular and ligamentous bed that supports the facet joints. This fixation prevents the facet joints from moving freely and results in limited ability to flex, bend, or twist the spine painlessly.

The facet-joint exerciser according to the invention is a wall-mounted device that comprises a wall mounting means and a pair of spheres. The spheres are mounted on a shaft, so that they roll freely about the shaft. Preferably, the wall mounting means allows height adjustability of the pair of spheres. The wall mounting means may be attached to a wall or a doorway jamb or casing. Important in the wall mounting is that the facet-joint exerciser be mounted to a surface that is sturdy enough to allow the mounting means be securely attached to it. The height of the pair of spheres is then adjusted to the desired height. To use the facet-joint exerciser, the user leans up against the pair of spheres with his or her back to the spheres, centering the spheres about each side of the spine, and pushes up and down against the spheres.

The facet joints of a vertebra are close together, typically within a range of about one to one and one-half inches apart on an average adult human. Accordingly, the spheres in the facet-joint exerciser according to the invention are held spaced apart a distance that accommodates the spine, but close enough to ensure that the spheres are forced to follow the contours of the spine and that the curved surfaces of the spheres move directly along the tissue that supports and surrounds the facet joints. The purpose of the spheres is to soften and gently release tension in the tissue of the spinal groove, as well as to correct the alignment and movement patterns of the deeper lying facet joints that are possibly subluxated. Proper use of the facet-joint exerciser also corrects vertebral rotations by applying bilateral pressure to the transverse processes. The vertebrae tend to self-correct when this type of pressure is applied. The spheres promote a resetting of fixated vertebrae by gently and thoroughly softening the supporting muscles and ligaments, allowing the facet joints to regain their freedom of movement as the spine is urged into flexion and extension as it moves along the spheres. The facet joints extend and close or flex and open as the spine is urged over the rolling spheres. This results in freedom from pain, increased mobility, greater homeostasis of the body's organs, improved body structure, and increased well-being.

The spheres must be constructed of a material that provides the desired firm pressure, but is not so rigid as to cause discomfort or be experienced as less than gentle. The spheres are best constructed as rubber balls, or as spheres with a hard core and a rubber coating or other type of compressible padding. The outer surface of the spheres may be smooth, textured, or have various patterns of therapeutic nodules or protrusions. Other materials and other combinations of materials may also be used for the spheres. The ideal sphere is one that provides the necessary firmness to move into the spinal groove along the facet joints, yet has enough give to it that it does not cause pain or harm as it does so.

### BRIEF DESCRIPTION OF THE DRAWINGS

The present invention is described with reference to the accompanying drawings. In the drawings, like reference numbers indicate identical or functionally similar elements. The drawings are not to scale.

FIG. 1 is a top plane view of the facet-joint exerciser, showing the spheres assembly clamped to the wall-mount track.

FIG. 2 is a front elevational view of the facet-joint exerciser according to the invention.

FIG. 3 is a superior view of a typical vertebra, showing the transverse processes, facets, and the spinous process, as well as the soft tissue that supports the spine.

FIG. 4A is a posterior view of the thoracic vertebrae, showing interlocking facet joints.

FIG. 4B is a posterior view of the lumbar vertebrae, showing interlocking facet joints.

FIG. 5 is a posterior view of the thoracic spine, illustrating the web of deep muscles and ligaments that attach to the spine.

FIG. 6 illustrates how the back-muscle exerciser according to the invention exercises the tissue and facet joints.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

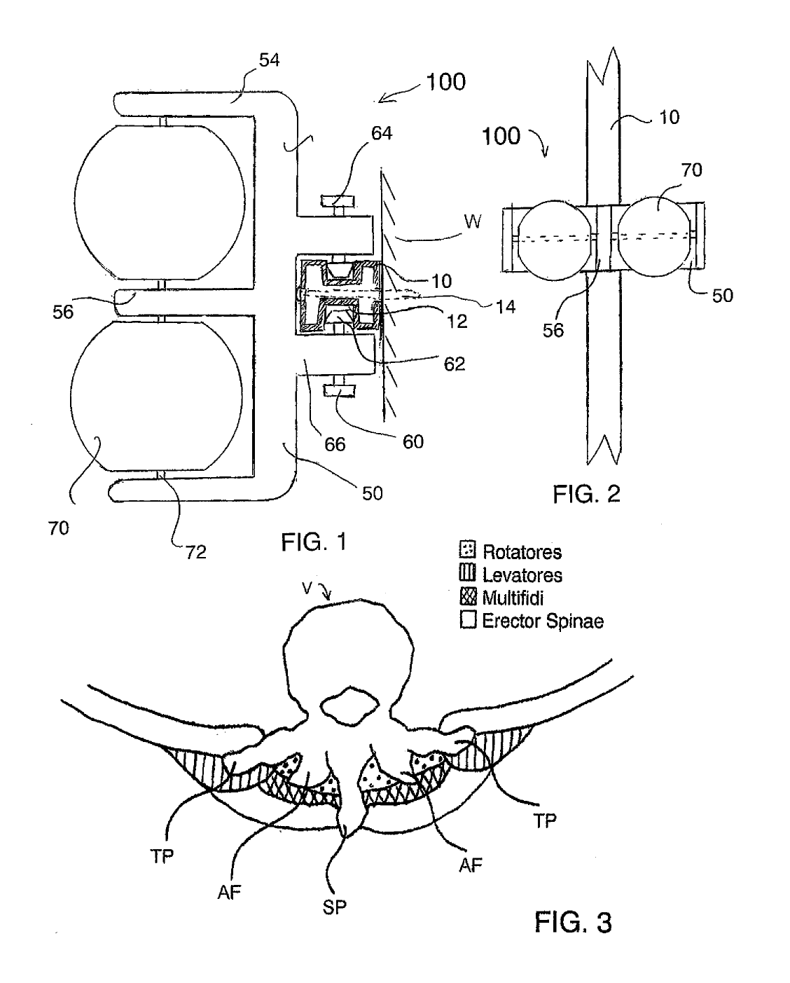

FIG. 1 and FIG. 2 are top plane and front elevational views, respectively, of a facet-joint exerciser 100 according to the invention. The facet-joint exerciser 100 comprises essentially a wall-mount track 10 and a massage device 50. The wall-mount track 10 is a metal track with grooves 12 along its sides and bores along the front and rear faces for receiving a fastening means 14 for affixing the wall-mount track 10 to a wall W or other support surface. The massage device 50 comprises a frame 52, in which a pair of spheres 70 are mounted, and an adjustable mounting means 60 for adjustably mounting the massage device 50 to the wall-mount track 10. The spheres 70 are free-rollingly supported on a shaft 72 that is mounted in the frame 50. The frame 50 is a double-ended yoke frame, having a double yoke on one end that comprises a pair of outer arms 54 and a central arm 56 positioned therebetween for mounting the spheres 70 and a mounting yoke 66 on the other end. The arms 54 and 56 are dimensioned such that they extend only a partial distance of the diameter of the spheres 50. The frame 50 is attachable to the wall-mount track 10 by means of the adjustable mounting means 60. In the embodiment shown in FIG. 1, the adjustable mounting means 60 comprises the mounting yoke 66, which has throughbores to receive a pair of wedging clamps 62 for securing the frame 50 to the wall-mount track 10. The clamps 62 clamp in the groove 12 of the wall-mount track 10 and have a knob 64 at the other end for loosening or tightening the clamp. The frame 50 may be secured in position at any point along the wall-mount track 10 simply by twisting the knob 64 to loosen the clamp, sliding the frame 50 to the desired location, and then tightening the clamp. The adjustable mounting means 60 shown is just one illustration of a suitable adjustable means for mounting the massage device 50 to the wall-mount track 10. Other types of mechanisms may also be used, such as a spring-biased locking-pin mechanism and a wall-mount track that has a series of spaced apart holes along the sides. One would slide the mounting yoke 66 along the wail-mount track 10 to the approximately desired height and then release the spring-biased pin, so that is then snaps into one of the holes.

The facet-joint exerciser 100 according to the invention is a height-adjustable device that allows a person to exercise the facet joints along the spine while maintaining an upright position. The wall-mount track 10 is best mounted to a wall W or a door jamb or casing, so that it is firmly attached. The massage device 50 is mounted on the wall-mount track 10 and secured in position at the desired height. The massage device 50 may be positioned at any point along the wall-mount track 10, as described above. Ideally, the person using the facet-joint exerciser 100 would mount the facet-joint exerciser 100 to a door jamb and adjust the height of the massage device 50 to correspond to the area of the spine that is to be exercised. The person leans with her back up against the massage device 50 and positions herself so that the pair of spheres 70 are positioned at each side of the spine. Now the person can move her spine up and down along the massage device 50, applying a pressure to the spine that is suitable for achieving the desired release of tension or exercising of tissue.

The illustrations show one massage device 50 mounted on the wall-mount track 10, although it is understood that multiple units of the massage device 50 may be positioned along the track. It is also possible to gang multiple units of the massage device 50 together.

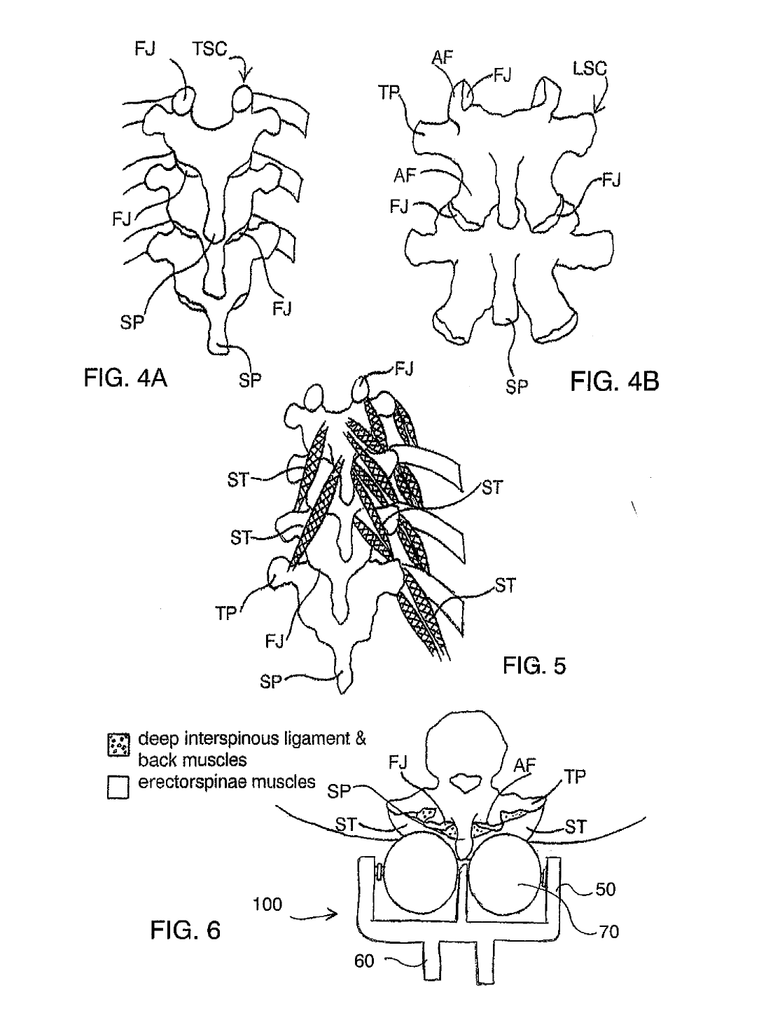

FIGS. 3-5 are provided to illustrate the complexity of the human spinal column and the particular areas that the facet-joint exerciser 100 effectively treats, in order to better understand the efficacy of the invention. FIG. 3 is an illustration of a typical vertebra V, showing transverse processes TP, articular facets AF, the spinous process SP, the vertebral foramen VF and the vertebral body VB. FIGS. 4A and 6B are posterior elevational views of the thoracic spine TSC and the lumbar spine LSC, respectively, showing interlocking facet joints FJ. FIG. 5 is an illustration of the web of muscles and ligaments, referred to collectively as supportive tissue ST, that attach to the spinal column SC. The muscles include rotator, levitor, and the multifidi muscles. These figures are provided only for purposes of illustration. They are not intended to provide an anatomically precise view of the human spine, but rather, to give a general idea of the structure of the posterior spinal column SC and the supportive tissue ST that attaches to it.

FIG. 6 is an illustration of how the massage device 50 of the facet-joint exerciser 100 achieves the goal of releasing tension and correcting subluxation. The illustration shows a superior view of the human spinal column SC with supportive tissue ST, such as deep interspinous ligaments, back muscles, and erector spinae muscles. The spheres 70 of the massage device 50 are dimensioned to fit up close to either side of the spinous process SP and push against the supportive tissue ST. As can be seen in this illustration, the arms 54 and 56 are a distance back from the circumferential portion of the spheres that is providing pressure against the supportive tissue ST.

In the human spine, the facet joints are substantially equidistant from each other along the entire length of the spine. For this reason, in a preferred embodiment of the facet-joint exerciser 100 constructed for the adult human spine, the spheres 70 have a diameter in the range of 1.5 inches to 3 inches. although the spheres may range in size from 0.25 to greater than 3 inches, depending on the intended use of the facet-joint exerciser 100. Two spheres 70 are spaced far enough apart on the shaft 72, so as to place a sphere on each side of and close to the spine. As mentioned above, it is possible to mount multiple units of the massage device 50 on the wall-mount track 10. It is possible to mount multiple massage devices 50, some of which are intended to massage distinct areas of the spine. For example. multiple massage devices 50 may be spaced apart on the wall-mount track 10, so that a first massage device 50 makes contact with the cervical and thoracic regions of the spine and a second massage device 50 makes contact with the lumbar region. The spheres 70 may be sized and spaced apart differently to accommodate the different sizes of the vertebrae along the spine. For example, in the area for the cervical and/or thoracic regions, where the vertebrae are quite small, the spheres 70 may be just far enough apart to ensure that they rotate freely and independently of each other, for example, only 1 mm or 0.0394 inch apart, whereas for the lumbar region, where the vertebrae are slightly wider, they may be as much as 1.27 mm or 0.5 inch apart. Any dimensions provided herein are provided merely for guidance in configuring a facet-joint exerciser that is sized for the average human adult. The dimensions of the spheres and the spacing between spheres 70 in the frame 50 may vary, depending on the particular intended use of the facet-joint exerciser 100.

The spheres 70 may be constructed of a natural or a synthetic material. Ideally, the spheres 70 have a hard core and a somewhat soft or compressible outer surface. The outer surface may be smooth or textured. The frame 50 with the arms 54 and 56 and the mounting yoke 66 may be constructed as a unitary component or the mounting yoke 66 may be a separate component that is fixedly attached to the frame 50.

The embodiments of the invention mentioned herein are merely illustrative of the present invention. It should be understood that a person skilled in the art may contemplate many variations in construction of the present invention in view of the following claims without straying from the intended scope and field of the invention herein disclosed.

1. A facet-joint exercise device for massaging tissue around a spinal column of a user, the facet joint exercise device comprising:
a pair of spheres mounted in a frame, the frame having a mounting yoke;
a track for mounting the frame to a vertical support surface; and
a means for adjustably securing the frame to the track;
wherein the spheres are mounted on a shaft in the frame, so as to be freely rotatable about the shaft, and wherein the frame is height adjustable on the frame.

2. The facet-joint exercise device of claim 1
the spheres are spaced a distance apart to accommodate the spinous process on the spine between the spheres and are dimensioned such that the spheres press into the support tissue on either side of the spine.

3. The facet-joint exercise device of claim 1, the frame having a sphere-mounting means for mounting the spheres, wherein the sphere-mounting means has a double-yoke comprising two outer arms and a center arm that is spaced equidistant from the two outer arms, and wherein the shaft extends from one outer arm to the center arm and from the center arm to the other outer arm.

4. The facet-joint exercise device of claim 1, wherein the means for securing the frame to the track includes a locking means that is provided on each arm of the mounting yoke and a groove along each side of the track for receiving the locking means, and wherein the locking means is adjustably movable on the track to a desired position.

5. The facet-joint exercise device of claim 4, wherein the locking means is a clamp body that is selectively positionable between a clamping position and a release position.

6. The facet-joint exercise device of claim 4, wherein the track has a series of spaced apart holes along at least one side of the track, and wherein the locking means is a spring-biased pin that is selectively insertable into a selected hole, so as to secure the position of the frame on the track.

7. The facet-joint exercise device of claim 1, wherein the spheres have a smooth outer surface that is compressible.

8. The facet-joint exercise device of claim 1, wherein a plurality of compressible protrusions are provided on the outer surface of the spheres.

9. The facet-joint exerciser device of claim 1, wherein the spheres have a hard core and a compressible outer surface.

10. The facet-joint exerciser device of claim 1, wherein the spheres are constructed of a natural material.

11. The facet-joint exerciser device of claim 1, wherein the spheres are constructed of a synthetic material.

12. The facet-joint exercise device of claim 1, wherein the spheres are made of wood.

13. The facet-joint exerciser device of claim 1, wherein a plurality of frames are mounted on the track.
